(19) United States
(12) Patent Application Publication
(10) Pub. No.: US 2024/0056545 A1
(43) Pub. Date: Feb. 15, 2024

(54) METHOD FOR PERFORMING COLOR SPACE TRANSFORMATIONS

(71) Applicant: GMG GmbH & Co. KG, Tübingen (DE)

(72) Inventor: Johannes Hoffstadt, Ulm (DE)

(73) Assignee: GMG GmbH & Co. KG, Tübingen (DE)

(21) Appl. No.: 18/234,075

(22) Filed: Aug. 15, 2023

(30) Foreign Application Priority Data
Aug. 15, 2022 (EP) 22020390.5

(51) Int. Cl. H04N 1/60

(52) U.S. Cl. CPC H04N 1/6058; H04N 1/6025; H04N 1/603; H04N 2201/214

(57) ABSTRACT

The application is directed to a method for carrying out color space transformations where, despite the use of regular multidimensional tables with the highest possible accuracy, a high throughput is achieved in color transformations and, simultaneously, full control over the transformation in each color space is achieved. The method includes computer-aided execution of transformations of color data for a project from a source color space to a target color space using transformation tables based on a transformation rule where a multiplicity of input color data of the source color space are in each case assigned unambiguous output values of the target color space. The source color space includes n colors and the target color space includes m values. Values for the target color space are generated for all input color data of the project using the transformation tables and are available in a data set.

The present invention relates to a method for performing transformations of color data for a project from a source color space to a target color space using transformation tables based on a transformation rule.

In the printing industry, color transformations are very often required to produce the data sets for the color printed products to be printed.

The starting point is digital layouts, which may contain, for example, color images from photography or scanning, illustrations and text. These layouts are templates that are to be reproduced accordingly in the form of printed products. Such a layout has been designed or developed in whatever form and represents, in terms of color appearance, what is desired for the intended purpose. Each individual layout object therefore has a color appearance that can be clearly identified. As is well known, color appearances are created by mixing only a few colors, for printed products, for example, by simply printing screened inks over one another, each color making a certain contribution through its effect, and the final result being created in the interaction of the different color layers.

The color appearance of each layout object is defined by its color values (of image pixels, outline colors, or fill colors), which represent the data source. In the case of image pixels, there are often millions of pixels, each with its own color values. These source color values always refer to a source color space with a specific number of colors. This means that each object in the layout is assigned a color space, which usually has a relationship to a device, often a very specific RGB color space such as sRGB or Adobe RGB, or a CMYK color space, only black (grayscale) or another printing color space. The object color values are quantified accordingly as RGB values, CMYK or grayscale values (0-100% color), or other color values. The total number of device colors of the source color space is denoted here by n.

Color spaces are usually described by ICC color profiles (ISO 15076-1:2010), layouts by PDF and PDF/X files (ISO 15930 series) that contain or can reference these ICC color profiles. For the most different reasons and motives the layout is to be reproduced. A wide variety of printing processes and presses are available for reproduction. These have the possibility to apply a certain number of colors in a certain way on a carrier material. These are the device colors of the printing system. These define or are the basis of the target color space, which in turn comprises all conceivable combinations of the device colors of the printing system. It can also be the device colors of a monitor. These are referred to as the m device colors of the target color space. Transformations into device-independent values are also often necessary, such as Lab or spectral colors, for example to be able to check the results of later measurements of printouts or to provide a device-independent database for display on any device. This is why the term m values of the target color space is used as a generic term.

Standardized color spaces are often used as source color spaces when designing the layout, but printing takes place by means of concrete output systems with their own individual color behavior. Therefore, for each halftone dot of the layout, it is necessary to transform the given combination of the n device colors of the source color space into a combination of the m values of the target color space required for further processing. The aim is to produce a result that is as close as possible to the original, i.e. the digital layout, i.e. ideally produces the same appearance for the viewer.

A halftone point or pixel is any point on a layout that results from a specified rasterization of the layout objects. This in turn is related to the so-called resolution of the representation, for example, for the creation of the print form. If a grid with i rows and j columns is laid over a layout, this results in a resolution of i×j pixels. Each individual pixel can now be identified with regard to its color construction.

Color transformations are used, among other things, to convert the layout data into printable data for a desired set of printing colors. This results, for example, in uniform, pure CMYK data for offset printing. Color transformations are also used to simulate the color appearance of these print data in a binding manner before printing. The color appearance is usually described device-independently in the CIELAB color space (Lab for short) or with the aid of spectral reflection factors. The print data with its assigned color space is transformed into these device-independent color data. These are displayed on a calibrated screen or with special proof printing systems (a so-called “proof”, usually with inkjet systems). Related to this is the task of adapting print data for other printing processes, i.e. generating new print data for other inks from existing print data by means of a transformation, while retaining the original color impression as well as possible.

For the usual printing processes with usually no more than four colors, these transformation processes are largely tapped and standardized by corresponding data systems.

However, in packaging printing, for example, more than 4 printing colors are very often used. Traditionally, brand colors are added as spot colors and images are built up with product-specific colors (e.g. dairy products with an additional light gray printing color, chocolate products with various brown printing colors). For transparent film packaging, white printing ink is often used in addition. Each ink used occupies a printing unit in the press and requires its own printing forme for ink transfer. The colors are applied one after the other, and in principle all colors can be combined with each other (overprintable). The totality of the separate printing forms leads to the term “separation” as a process or result of the creation of the print data.

Machines with 7-10 inking units are not uncommon in flexo, offset and gravure printing. Designers for branded products can select the printing inks from thousands of spot colors, for example, from over 2000 shades in the PANTONE® system. These inks are produced and supplied by ink manufacturers. In so-called digital printing, inkjet and toner-based presses are used, which often contain 6-8 inking units, but are operated with fixed ink sets, since inkjet inks and colored toners often have to have very special, machine-dependent processing properties, or changing them would be too technically complicated. Typical color sets contain CMYK supplemented by orange or red, green, blue or violet, white.

Digital printing processes currently work more slowly than conventional printing processes, but since no printing forms have to be created and colors are not changed, the setup effort is much lower, making short runs more economical and personalized printing possible. Here, therefore, there is a desire to print an initially conventionally produced package in short runs or even personalized (run 1) as required, but the color appearance should be as identical as possible to previously printed products produced with individual spot colors. This is because different batches can stand side by side on the sales shelf. To achieve this, the print data available for the conventional printing process is converted from its source color space into a target color space that describes the digital printing process. In the extreme case of variable, personalized printing, different source data must be transformed for each copy, in which case the transformation becomes a bottleneck.

The color transformations mentioned at the beginning thus convert from a source color space Q (for example with n device colors) into another target color space Z (for example with m device colors or the 3 CIELAB values L, a, b). This is done by applying a transformation rule TRV. These can be calculation formulas, transformation models or transformation tables already created based on TRV. They must be applied often per pixel, so high throughput is important (millions of pixels per second). To achieve this, interpolation is done in a prepared table, such as in the ICC industry standard. The table is built for combinations of n color values. Each of the n input colors can take values between 0 and 100% ink coverage. The table cannot list all combinations, but samples each input color at a certain specified resolution. It is a regular rectangular n-dimensional grid containing all combinations of the sampled levels. In between, n-dimensional interpolation is applied. The accuracy depends on the sampling. Typical samples are for n=3 (RGB/Lab) 33 steps (33³≈36000 table entries), for n=4 (CMYK) 17 steps (every 6.25%, 17⁴≈84000 table entries). The number of gradations is the base of the power, the number n of inks is in the exponent. The generation of transformation tables are measures that are familiar to those skilled in the art. They are based, for example, on the spectrometric measurement of printed inks, calculations for estimation and/or interpolation, and the like.

The table size increases exponentially with the number n of input colors. Because the memory space is limited, the sampling must become coarser for practical reasons. For the frequent case n=7, often only 6 or 7 levels are used. An example is the widely used open source color management system LittleCMS, which uses 7 stages (every 16.67%, 7⁷≈820000 table entries). The table structure therefore leads to the following problem: the more inks, the larger the table, and the fewer gradations can be stored. Users expect a comparable accuracy with CMYK+additional colors as they are used to with CMYK. 7 steps are considerably too coarse.

Known solution approaches are disclosed in DE 10 2004 003 300 A1, according to which assignment tables that have more than four input color components are divided into several assignment tables with a maximum of four input color components. This technique is intended to solve the problem of assignment tables that are too large. It is a concrete proposal to solve this problem by basically reducing to 4-component tables, according to convention, since the prior art takes advantage of the fact, valid at its time, that even in seven-color printing, usually no more than four colors are printed on top of each other at one point on the printed sheet. For this reason, the reduction to 4-component tables is also being pushed. To ensure this in case of doubt, additional processes such as Gray Component Replacement (GCR) and Color Component Replacement (CCR) are applied when creating the separation table. A similar prior art results from Boll H: “A COLOR TO COLORANT TRANSFORMATION FOR A SEVEN INK PROCESS”, PROCEEDINGS OF SPIE, IEEE, US, Vol. 2170, Feb. 1, 1994 (1994-02-01), pages 108-118, and U.S. Pat. No. 5,892,891 A.

Known solution approaches use a model or a combination of table and model. A model is usually a mathematically based transformation rule. In this way, the Lab color value of an overprint can be estimated from the individual printing colors. This is done, for example, when displaying layouts or PDF files on the screen and is fast but inaccurate. In the ICC further development iccMAX it is suggested to spectrally offset single colors, or to use tables for the CMYK portion and to modify their value for each additional color. In all cases, adding individual colors is too inaccurate because it does not or insufficiently take into account the interaction of colors in overprints in which these colors are involved.

There are more accurate models that better calculate the overprinting behavior of color mixtures, but they are nowhere near fast enough to be useful for transforming millions of pixels. In addition, the models provide Lab values or spectra, but no device color values, so they are not suitable for direct device-to-device (“device-link”) transformation. This is because the device color values to be output are often subject to special separation rules (see below) and usually require special processing for high quality. However, the transformation into device colors is an extremely common application.

The invention is based on the task of improving a method for performing color space transformations in such a way that, despite the use of regular multidimensional tables with the highest possible accuracy, a high throughput of color transformations can be achieved and, at the same time, full control over the transformation in each color space can be maintained.

The technical solution to this task consists in a method with the features of patent claim 1. Further advantages and features result from the subclaims.

The n colors of the source color space are given, that is, how many and which colors in the source color space are intended for this project. These include standard colors, base colors, etc. And they include special colors that are brand-specific, for example.

Furthermore, the m values of the target color space are specified.

The transformations are performed using transformation tables.

According to the invention, all color combinations of the n colors of the source color space whose color components are not zero are determined. For each of these color combinations a subspace table is generated and stored. Finally, all true subsets including the null set for each of these subspace transformation tables are generated and stored as separate, redundant subspace transformation tables.

The entirety of these stored subspace transformation tables is applied for the transformation by assigning the corresponding subspace transformation table for each combination with its color components of the n colors based on those color components that are not zero.

The invention has the advantages that the selection of the appropriate transformation table is simpler, the selected table has the smallest possible dimension (and thus the most efficient interpolation), and finally the data to be transformed does not have to be laboriously augmented with empty dimensions to match an existing but larger table. In contrast, the redundant tables require very little additional memory.

According to another advantageous proposal of the invention, instead of generating subspace transformation tables, already existing ones are determined and stored. This saves computing steps.

Some colors are not used at the same time, e.g. complementary color pairs are not used because print variations would have an effect in diametrically opposite color directions, i.e. would be unstable. Such neutralizing color tones can be achieved much more easily and stably with other colors (gray tones, for example, with black).

In common periodic printing screens, there are only 4 patterns available that can be overprinted without interference noise (moiré) or sensitivity to alignment errors (register variations), so in this case there are no more than 4 screened colors. Even without such limitations due to screen technology, combinations of 3-4 colors are usually sufficient.

In addition, the total ink coverage is limited, often only 200% to 400% total coverage can be processed well in terms of printing technology (adhesion, drying). This also results in a criterion for reducing generated and stored data, since combinations exceeding the total ink coverage do not have to be taken into account.

Such rules initially concern the target color space Z for generating the separation in color transformations, but as soon as print data are available, they also become a source for determining the color appearance. Therefore, these rules also describe the expectation of which color combinations of the source color space Q can potentially occur.

According to the invention, all required or specified combinations of the n colors of the source color space Q are formed from the n colors of the source color space Q and a subspace transformation table is stored for each combination, in which a color combination of the m colors of the target color space Z is assigned to each color combination of the colors of the source color space Q, and these subspace tables are used for the color space transformations. The extraction of the m colors of the target color space Z from the tables can be done directly or indirectly, for example after a corresponding further calculation or interpolation.

Based on a method for performing transformations of color data for a project from a source color space with n colors into a target color space with m colors, using transformation tables in which a plurality of input color data of the source color space are each assigned unique output color data of the target color space, wherein color data for the target color space are generated for all input color data of the project using the transformation tables and are made available in a data set by taking the corresponding output color data directly or indirectly from the transformation tables for input color data, the color data of each layout object of a project present in the source color space are translated to a certain extent into the color data in the target color space.

The invention provides for storing accurate tables even with many colors and for direct conversions (n colors Q to m colors Z). For this purpose, the number of stored entries is intelligently reduced according to the invention.

According to the invention, it is thus proposed to store subspace tables instead of a complete table for the entire n-dimensional color space. Each of the n colors must occur in at least one subspace. A k-dimensional subspace is formed by selecting k out of n colors.

According to an advantageous proposal of the invention, each of the n colors shall be sampled in the same way from 0 to 100% in all subspaces in which it occurs to guarantee consistency.

According to the invention, it is envisaged that subspaces have intersections of identical redundant entries. These must match for consistency. For example, each table redundantly contains the k-dimensional zero combination (the entry of the unprinted substrate).

The invention now makes it possible to adapt a usual color transformation: for each input color (i.e. each combination of the n colors to be transformed), those of the n components that are not zero are determined. So the corresponding subspace is determined. Now it is checked whether there is a table for this subspace. This will be the case if all relevant color combinations have been considered. Then the non-zero input values are interpolated in it.

Interpolation can be done e.g. by k-dimensional interpolation methods like multilinear or n-simplex interpolation.

If there is no matching table, the request is invalid, i.e. the input color data are outside the subset combinations of the n colors provided in the project. Then, for example, abort or generate special signal colors as output color data to signal that the input color data do not meet the requirements. By this adaptation any heterogeneous subspace mixtures are possible, depending entirely on the requirements of the application.

In order to apply the associated subspace faster, it is proposed to store all lower-dimensional subspaces as separate redundant copies from the stored subspaces. Due to the exponential size relation, these additional low-dimensional copies are small against the actual data.

According to the invention, identical values in redundant tables are guaranteed by not having any redundancy in the saved file format for the table structure, namely by first saving the zero-dimensional subspace, then the added 1-dimensional subspaces without the zero-level, then the added 2-dimensional subspaces without the zero-level, and so on. When reading in, the incomplete subspaces are completed by adding the zero levels from the lower-dimensional tables.

Furthermore, the invention proposes to efficiently locate and assign subspace tables by describing subspaces with a binary numerical value that assigns a bit to each of the n dimensions. The bit is set to 1 if the color value is >0, otherwise to 0. Thus, an assignment of up to 2ⁿ subspace tables is possible directly via a list of entries from 0 . . . 2ⁿ−1.

While motley subspace tables allow maximum flexibility, it may be advantageous to use homogeneous, complete subspace tables. For example, by convention, only subspaces with the same dimension k can be used, or even all of the k out of n combinations of subspaces can be stored, so meaningless combinations cannot be omitted (e.g., complementary colors or colors that have the same periodic screening). The advantage is a reduction of case distinctions between existing and non-existing table entries, which generating, visualizing or editing programs would have to be able to handle. However, it is also easy to determine what degree of homogeneity or completeness any subspace structure has when it is read in, so that need not be specified per se.

In this simplified case of homogeneous and complete subspace tables, it is proposed according to the invention to choose the value k as a lump sum so that all relevant (to be transformed) color combinations are covered. As described above, a possible reasonable size for the graphical industry is k=4. Thus, tables would be generated for all relevant combinations that can be formed from 4 colors each. Then the real subsets including the null sets (i.e. direct printing on the substrate), are formed and the subspace transformation tables are determined.

The subspace transform table entries usefully correspond to a rectilinear grid, i.e., the Cartesian product of all combinations of desired gradations of each of the k out of n input colors that occur in the subspace.

The invention is explained further below by means of examples. Further advantages and features of the invention result therefrom.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 22020390.5, filed Aug. 15, 2022, are incorporated by reference herein.

As a first example serve a source color space with the colors C, M, Y (n=3). For the purpose of illustration, no 3-dimensional table is to be stored, instead only all subspaces with k=2 simultaneously occurring colors. Thus, the three subspaces CM, CY, MY would be stored. If only these tables are available, any query with less than 2 colors, say only M, must first be mapped to one of the matching subspaces. This would be either CM or MY. Both are equally good, since the tables must be consistent. In both cases, however, an additional zero would have to be correctly added for the 2-dimensional table interpolation (C=0 as the first value for CM, or Y=0 as the second value for MY). Thus, a cumbersome assignment and addition is required.

But if the 1-dimensional subspace M already exists, it can be used directly and the addition is not necessary. As a further advantage then the dimension of the table is smaller, so that the multidimensional interpolation is faster in it. In the 0-dimensional case it is even only the reading of the one data point. Therefore it is useful to have the tables of the additional redundant lower-dimensional subspaces available for transformations.

Since they are redundant, they can be easily completed from the stored subspaces. See also FIG. 3. Thus all lower-dimensional subspaces are generated from CM, CY, MY:

From CM, the 1-dimensional tables for C (with M value 0) and for M (with C value 0) would be added.

From C, the 0-dimensional table of the unprinted substrate (with C value 0) would be added. Likewise from M, but it already exists.

From CY, C already exists, only the 1-dimensional table Y (with C value 0) is added.

From MY, M and Y already exist, no other 1-dimensional table is added.

A size consideration for the additional memory requirement for the redundant tables: If all colors were in 10 levels, the stored tables CM, CY, MY would each have 10²=100 entries (total 300). The additional tables C, M, Y would have 10 entries each, the 0-dimensional table of the substrate would have 1 entry (total of 31 additional generated entries). The additional effort here is still a good 10% (331 instead of 300 entries), but becomes much smaller as the number of colors n increases. The non-saved complete CMY table, on the other hand, would have 10³=1000 entries.

The above example again serves to explain the naming of tables by binary numerical values. The powers of two 4,2,1 are assigned to the colors CMY. The three 2-dimensional subspaces would have the binary number values CM:4+2=6, CY:4+1=5, MY:2+1=3. The generated 1-dimensional tables would be C:4, M:2, Y:1. The 0-dimensional table would have substrate:0. Thus, all number values from 0 to 6 are assigned subspace tables. Except for the number 2³−1=7, which would be the n=3-dimensional full table, which should not exist in the example.

With reference to guaranteeing identical values in redundant tables by a non-redundant storage format, the example CM can store the unprinted substrate (0-dim), then 1-dimensional increments of C>0, then 1-dim. increments of M>0, then the 2-dim. combinations of C>0+M>0. Referring to FIG. 4, the read would read the unprinted substrate (the zero entry), then the 1-dimensional gradations of C>0, to which the 0 is added so that the C table is complete, then the 1-dim. gradations of M>0, to which the same 0 is added so that M is complete. Then the 2-dim. combinations of C>0+M>0 are read, to which the 0 is added at the corner and the 1-dim. C and M at the edges, so that CM is complete. For further tables, for example CY, MY, it goes analogously the same way.

In another example, consider 7 colors (CMYK+3 others) with a resolution of 17 levels (typical CMYK resolution). The complete table would have 17⁷≈410 million table entries. If, on the other hand, we need only subspaces with k=4 dimensions, there are initially 35 ways to select 4 out of 7 colors. Each of the 35 tables would have 17⁴≈84000 table entries, all together 2.9 million. No combinations have yet been omitted that contain irrelevant color pairs (see FIG. 5). Nevertheless, the overhead is more than 100 times lower. This concerns not only the storage space, but also the computation time for the creation, for example with complex models. All color combinations with at most k components can be interpolated quickly and accurately.

The additional redundant subspaces with k<4 generated for the transformation are: 35 subspaces for 3 of 7 colors, 21 subspaces for 2 of 7 colors, 7 subspaces for 1 of 7 colors, 1 subspace without color. In total, these are 35*17³+21*17²+7*17¹+1*17⁰=178144 entries or just 6% additional main memory requirements.

In another example, consider 15 colors (upper limit in ICC profiles) with a resolution of 10 levels (all 11%). The full table would have 10¹⁵=1 quadrillion table entries and would be much too large. But for 4 out of 15 colors there are only 1365 possibilities, each of the 1365 tables would have 10⁴=10000 table entries, all together 13.65 million. The additional redundant tables for 3 out of 15 (455), 2 out of 15 (105), 1 out of 15 (15) and 0 out of 15 (1) need 455*10³+105*10²+15*10¹+1*10⁰=465651 entries or about 3% additional main memory requirements. The memory requirement would be far below 1 GB and thus still manageable.

The invention describes a novel method for the preparation and provision of transformation tables. This results in novel devices for performing corresponding transformations, consisting of computer systems with corresponding input and output devices as well as processors and memory units on which the transformation tables according to the invention are managed. The combination of the hardware, the data and the corresponding software result in a method for performing color space transformations.

The invention describes a solution that is practicable and feasible for the person skilled in the art, with which a sufficiently fast and high-quality color space transformation into the color space of the concrete printing system is possible even with very high resolution of a layout and a large number of source colors.

### BRIEF DESCRIPTION OF THE DRAWINGS

Further advantages and features result from the following description based on the figures. Thereby show:

FIG. 1 shows a flow chart explaining the process steps.

FIG. 2 shows a flowchart explaining the transformation.

FIG. 3 shows the complement of lower-dimensional subspace tables.

FIG. 4 shows the construction of subspace tables from redundancy-free storage.

FIG. 5 shows complete and relevant subspace tables for a 7 color example.

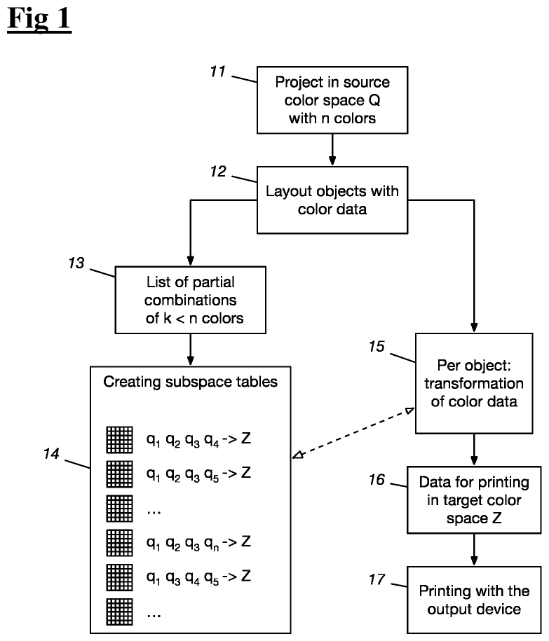

According to FIG. 1 there is a project 11 to be displayed, for which in 12 the entirety of the color data of each layout object is available in the source color space with n colors.

In process step 13, the partial combinations are formed from k<n colors. A subspace transformation table is generated for each partial combination in step 14. The real subsets of it are not shown here. In step 15, the color data of the n colors of each layout object are transformed into color data of the m colors of the target color space using the subspace transformation tables from step 14. From this, in step 16, the print data is compiled for the result 17, which is generated on an output device with m device colors.

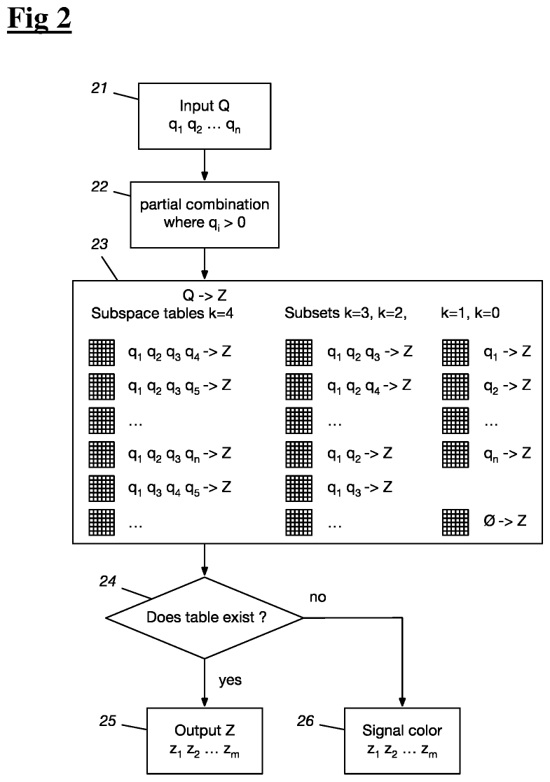

FIG. 2 shows the transformation 15 in detail. The input 21 is the color data of the source color space with n colors for an object. In step 22, the corresponding partial combination is determined, which consists of the parts that are not zero. In step 23, the previously formed subspace tables as well as their true subsets are searched to see if there is a table that contains this partial combination 22. In step 24, the result is checked. If the subspace tables 23 were created suitable for the input 21, there is at least one suitable table, from which as result 25 the color data of the m colors of the target color space are determined. If no table was found, an error is signaled in step 26, e.g. by a signal color consisting of special m color values of the m target color space.

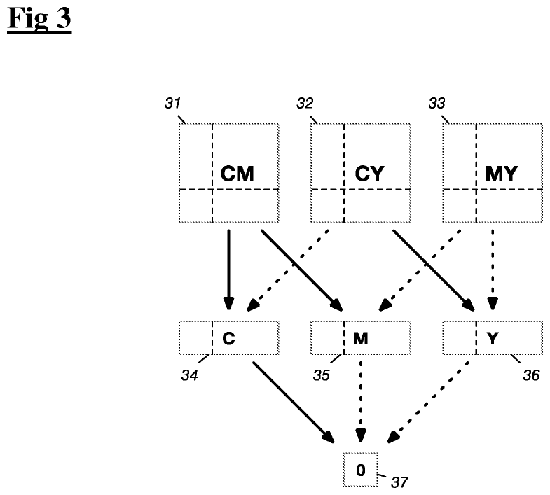

FIG. 3 shows an example of the three 2-dimensional subspace tables 31, 32, 33 for CM, CY and MY. The redundant 1-dimensional subspace tables 34, 35, 36 for C, M, Y can be extracted from 31-33. Thus, C can be obtained from CM or CY, M from CM or MY, Y from CY or MY. The redundant 0-dimensional subspace table 37, which contains only the unprinted substrate, can be obtained from any of the higher-dimensional tables.

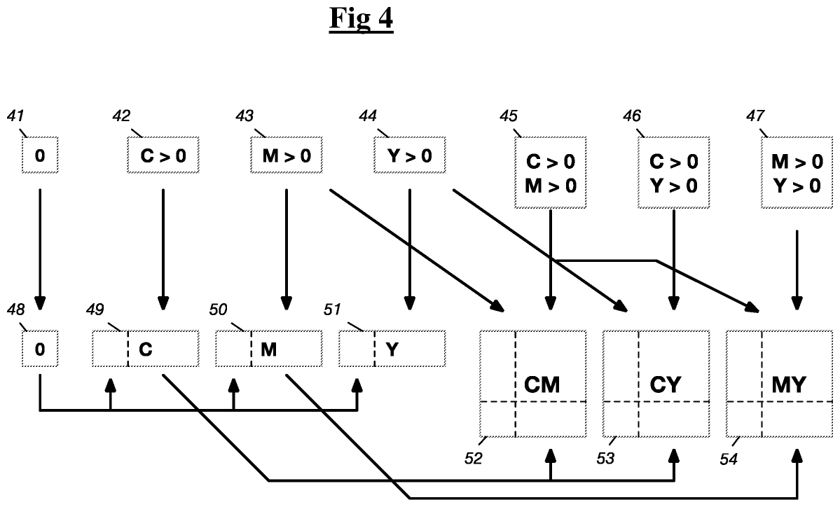

FIG. 4 assumes a storage format without redundancy. All subspace tables are stored without the null elements of one or more colors, i.e. in an abbreviated form. Thus, there is no overlap between the stored tables. The only zero element 41 is the 0-dimensional table with the entry for the unprinted substrate. The 1-dimensional abbreviated tables 42, 43, 44 for C, M, Y are connected with the zero element 48 (corresponding to 41) and thus completed to the complete 1-dimensional subspace table 49, 50, 51, in which now interpolation can be done as usual. Similarly, the 2-dimensional truncated tables 45, 46, 47 are completed with the lower-dimensional tables, yielding tables 52, 53, 54. The procedure is continued analogously for all stored truncated tables.

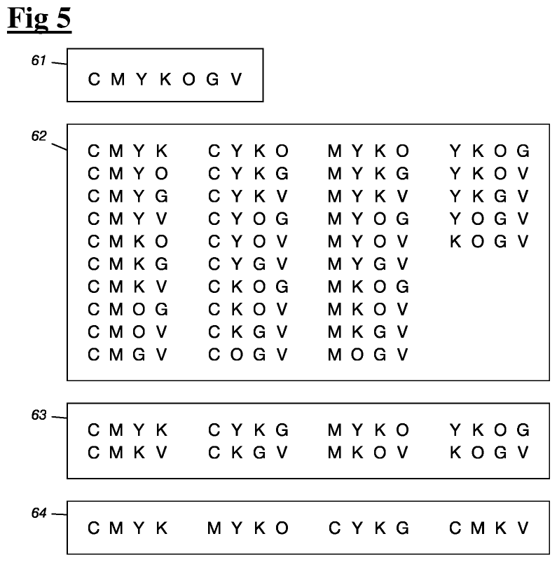

FIG. 5 shows for a source color space 61 with the 7 colors C, M, Y, K, O, G, V the complete list 62 of all 4-dimensional subspaces. These are the 35 combinations of how to select 4 out of 7 colors. If no color combinations containing complementary colors are used in printing projects, the necessary list is reduced to the 8 subspaces shown in 63. Finally, if the additional colors O, G, V are each used only in their own hue sectors, i.e. not together, only 4 subspaces remain as shown in list 64.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### REFERENCE SIGN

11 Project in source color space with n colors
12 Layout objects with color data
13 List of partial combinations of k<n colors
14 Creating subspace tables
15 Transformation of the color data
16 Print data in target color space Z
17 Printing with the output device
21 Input of the color data of the source color space with n colors
22 Determining the partial combinations
23 Searching the subspace table
24 Checking the result
25 Applying the table and outputting the color data in the target color space
26 Error signature
31, 32, 33 stored subspace table
34, 35, 36, 37 extracted lower dimensional table
41 0-dimensional table
42, 43, 44 1-dimensional table without zero values
45, 46, 47 2-dimensional table without zero values
48 0 element
49, 50, 51 1-dimensional table connected with 0 element
52, 53, 54 1-dimensional table associated with 0 element
61 Source color space with 7 colors
62 List of 4-dimensional subspaces
63 Reduction with abandonment of complementary colors
64 Reduction due to additional color separation

1. Method for the computer-aided execution of transformations of color data for a project from a source color space into a target color space using transformation tables based on a transformation rule, in which a plurality of input color data of the source color space are each assigned unique output values of the target color space, wherein the source color space comprises n colors and the target color space comprises m values, wherein values for the target color space are generated for all input color data of the project using the transformation tables and are provided in a data set by taking the corresponding output values for input color data from the transformation tables, characterized by the following features:
a) Determine all color combinations of the n colors of the source color space whose color components are not zero;
b) Generate and store a subspace transformation table for each of these color combinations;
c) Form all true subsets, including the null set, to each subspace transformation table and generate and store them as separate, redundant subspace transformation tables;
d) Using the stored subspace transformation tables for the transformation by assigning for each input with its color components of the n colors the corresponding subspace table based on those color components that are not zero.

2. The method according to claim 1, characterized in that step b) is divided into
b1) Determine and store already existing subspace transformation tables to determined color combinations;
b2) Generate and store a subspace transformation table for each of the color combinations for which no existing subspace transformation table was determined in b1).

3. A method according to claim 1, characterized in that for each of the n input colors a stepwise gradation from 0 to 100% is determined according to an accuracy predetermined for the project and these gradations are used for the formation of the subspace-transformation tables.

4. A method according to claim 1, characterized in that in the application of the subspace transformation tables the output values are interpolated.

5. Method according to claim 1, characterized in that the values of the target color space are device-dependent values.

6. Method according to claim 1, characterized in that the project is a printing project with a restricted total color application which can be processed by printing technology, for which only subspace transformation tables are stored and used which do not exceed the total color application of the input color data permitted in the project.

7. Method according to claim 1, characterized in that the values of the target color space are device-independent values.

8. Method according to claim 1, characterized in that the subspace transformation tables are indexed by means of a binary numerical value having a set bit at position 2ⁱ for each color i occurring in the subset out of the total n colors numbered from 0 to n−1, and likewise each input color datum is designated by a further binary numerical value with set bits for those of its n components which are not zero, so that the associated subspace table can be selected directly via this binary numerical value of the input color datum.

9. Method according to claim 1, characterized in that the method is carried out on a computer unit by means of control software, the computer unit comprising an input unit for providing the digital color data of the project and an output unit for outputting the transformed color data as well as a memory on which the transformation tables are stored, values for the target color space being generated by means of the control software for input color data of the project using the transformation tables and being provided in a data set.
